(19) United States
(12) Patent Application Publication
(10) Pub. No.: US 2020/0009967 A1
(43) Pub. Date: Jan. 9, 2020

(54) SAFETY DISCONNECT SYSTEM

(71) Applicants: Carlile R Stevens, Granite Shoals, TX (US); Robert Wright, JR., Louisville, KY (US); James E. Maddox, III, Louisville, KY (US)

(72) Inventors: Carlile R Stevens, Granite Shoals, TX (US); Robert Wright, JR., Louisville, KY (US); James E. Maddox, III, Louisville, KY (US)

(21) Appl. No.: 16/026,425

(22) Filed: Jul. 3, 2018

(51) Int. Cl. B60L 11/18; H02J 7/00; H02H 5/10

(52) U.S. Cl. CPC B60L 11/1844; B60L 11/1825; H02H 5/10; H02J 7/0031; B60L 11/1816

(57) ABSTRACT

A device and method for assuring fail safe operation of an energy vending system. Such systems are primarily used to recharge the batteries in electric vehicles. Fail safe operation assures that any failure of the energy vending system automatically disables all forms of energy release that could cause harm to individuals or property in the system's vicinity. All forms of failure such as earthquake are included but failure caused by accidental disruption such as a vehicle crash is considered primary.

### TECHNICAL FIELD OF THE INVENTION

The present invention relates to the field automotive electrical charging enclosures, more particularly to safety circuits or devices which disconnect the electrical power feed to the enclosure if the enclosure has been damaged in any way.

### BACKGROUND OF THE INVENTION

Plugin electric vehicles offer better fuel economy, lower emissions and good acceleration. Automotive manufacturers are introducing electric vehicles to the consumer market. At least one industry forecast predicts up to 400,000 battery powered electric vehicles in North America by the year 2020.

Chargers supply a connection to the grid for drivers on the go with a direct charge of electricity needed to recharge their battery. A typical charger station includes an energy source remotely located from a free-standing enclosure located next to where a vehicle to be charged is located.

Charging stations for electric vehicles are equivalent to gasoline and diesel pumps at filling stations as both are suppling energy to vehicles. Fuel pumps are usually guarded with heavy duty posts called bollards which are typically painted bright yellow for high visibility and are located at each of the four corners of the fuel service islands and usually close to the pumps. These posts are generally at least four inches in diameter and are generally steel pipes which may concrete filled or are constructed of steel reinforced concrete. These posts extend down into the foundation for increased strength. The purpose of the bollards is to prevent an out-of-control vehicle from striking a fuel pump and partially or totally dislodging the pump and cabinet from the foundation, at which point an explosion may occur due to the presence of leaking fuel and possible sparking of electrical wires.

Furthermore, electrical wiring may be exposed and cause severe or lethal shocks to anyone in the adjacent area. However, bollards typically don't cover the entire area around the fuel pumps and an out-of-control vehicle approaching from a given angle is capable of dislodging a pump and causing the dangerous situation as described above. Further, bollards are sometimes installed incorrectly or may have been knocked loose and cannot provide protection as originally intended.

With the advent of electrical cars and hybrid vehicles, electrical vehicle charging stations are appearing in many locations throughout the world. Many of these charging stations are similarly protected by bollards but many are not. And, as stated above, bollards don't totally prevent a vehicle from dislodging a charging station from a foundation. Obviously, such charging stations have high voltage wiring within the enclosure, generally entering from underground conduits within the foundation and going on up into the enclosure. These electric vehicle charging stations pose a possibly more serious electrical hazard than do common fuel pumps. Consequently, serious danger is present when the charging station enclosure is dislodged and high voltage wiring is exposed.

There is a possibility of damage to an electric vehicle charging station or other high voltage system due to a collision or being struck with a force sufficient to cause component failure, physical damage, systemic damage, or physical displacement; damaging high winds resulting from natural occurrences such as hurricane, tornado, etc.; high water or flooding events; excessive/violent/sustained physical motion/movement/shaking such as an earthquake; and/or physical damage resulting from vandalism or terroristic act.

The damage may be sufficient to cause the enclosure, pole/post, or supporting structure to become completely dislodged from its foundation, mount, or supporting system; become partially dislodged from its foundation, mount, or supporting system; sustain physical damage; sustain damage to the components contained/housed/enclosed/supported; and/or overheat causing damage to the components contained/housed/enclosed/supported thereby.

Moreover, exposure of the dangerously high voltage power feed, and its' conductors, terminals, or wiring causing physical contact with conductive metals, liquids, or a person/animal creates the possibility for shock or electrocution and fire or explosion. Exposure of the dangerously high voltage power feed cabling, conductors, terminals, or wiring causing electrification by proximity to conductive metals, liquids, or person/animal could also create the possibility for shock or electrocution and fire or explosion.

In the event the electric vehicle charging station is exposed to a substantial enough force to move the charging station from its the originally mounted position or wiring to the charging station should become exposed, a safety system should be in place to disconnect the incoming power at its source. Safety circuits which disconnect the incoming power in the event of a ground fault or in the event of a current overload are common in fuel pumping stations and EV charging stations can be found in the marketplace. A ground fault or over current circuit might disconnect the incoming power to a dislodged station if the dislodging resulted in a ground fault or an over current situation, but, it is possible that underground conduit may be broken, and wiring exposed without creating a ground fault or an over current situation. The present invention, however, provides a safety circuit which disconnects incoming power when the energy vending enclosure or wiring has become dislodged or damaged, to remove the chance of electrical shocks or electrocution of bystanders who are unaware of such dangers.

### DESCRIPTION OF THE RELATED ART

The best descriptions of related art are contained in these inventor's U.S. Pat. No. 9,368,959 issued Jun. 19, 2016. In that patent the primary novelty is the sending of a signal that shuts down the power if a fault is detected. In the current invention we cover the much safer alternative of not sending a signal if a fault is detected, therefor shutting down the energy if the signal is not present. We have not found such a signal description in the related art. The main problem in the related art is that if damage occurs such that all the wires delivering energy to the vending enclosure are cut then there will be no energy available to send the signal to cause the source of electrical energy to shut down as the wire delivering that shut down signal would most likely be also cut.

### SUMMARY OF THE INVENTION

The present invention provides a safety circuit for disconnecting electrical service in the event that the enclosure, pole/post, or supporting structure is exposed to catastrophic accident, incident, occurrence, or natural disaster occurs involving a utility power distribution system from the grid to sub-transmission/primary distribution/local distribution; and/or an electrical distribution/feed to an electric vehicle charging station, gasoline station pump, propane distribution system, chemical tank farm, petroleum tank farm, fuel farm, or highway/roadway/parking light pole & or lighting system.

In accordance with the present invention, there is provided an electrical vehicle charging system comprising an enclosure with associated means for vending energy to an electric vehicle. The enclosure is mounted on a foundation which is fixedly secured to a solid surface and receives its energy from a remotely located source of electric energy. The enclosure contains whatever sensors are needed to be sure there are no mal-functions that could cause any sort of harm to people or property. If no mal-function is detected the enclosure contains circuitry that causes a signal to be sent to the remotely located source of electrical energy. The presence of the signal maintains the main circuit breaker closed to allow power flow to the enclosure. If the signal is not received the main circuit breaker cannot close and no energy flows.

It is the object of this invention to provide a safety circuit which may be added to the normal circuitry within an electric vehicle charging station or a fuel pumping station which automatically removes electric power from the source of electric power as a result of damage or any mal-function, thus removing dangerous high voltage which may be exposed by such mal-function.

Other objects, features, and advantages of the invention will be apparent with the following detailed description taken in conjunction with the accompanying drawings showing a preferred embodiment of the invention.

### BRIEF DESCRIPTION OF THE SEVERAL VIEWS OF THE DRAWINGS

For a more complete understanding of the present invention and the advantages thereof, reference is now made to the following description taken in conjunction with the accompanying drawings in which like reference numerals indicate like features and wherein:

FIG. 1 Shows this invention as a block diagram of how the source of electric power interfaces with the enclosure vending power or fuel.

FIG. 2 Shows a block diagram of the vending enclosure's internal circuitry to facilitate explanation of the function of this invention.

FIG. 3 Depicts a schematic of one method of how the signal to the source of electrical energy is impressed on the main power lines when a system utilizing two or three phase electric power is employed with this invention.

### DESCRIPTION OF THE INVENTION

Embodiments of the present invention are directed to systems and methods that are further described in the following description and claims. Advantages and features of embodiments of the present invention may become apparent from the description, accompanying the drawings and claims.

The present disclosure teaches a system and method for an electrical vehicle charging station enclosure which monitors the originally installed position of the enclosure relative to the foundation or attachment on which the enclosure is installed generates a signal indicates that everything is as it should be allowing high voltage power to be fed into the enclosure. Additionally, the same safety system may be used on a fuel pump enclosure which is common in a typical gas station or fuel delivery system to prevent danger from exposed electrical cables in the event of damage or dislodging of the fuel pump enclosure or fuel delivery system.

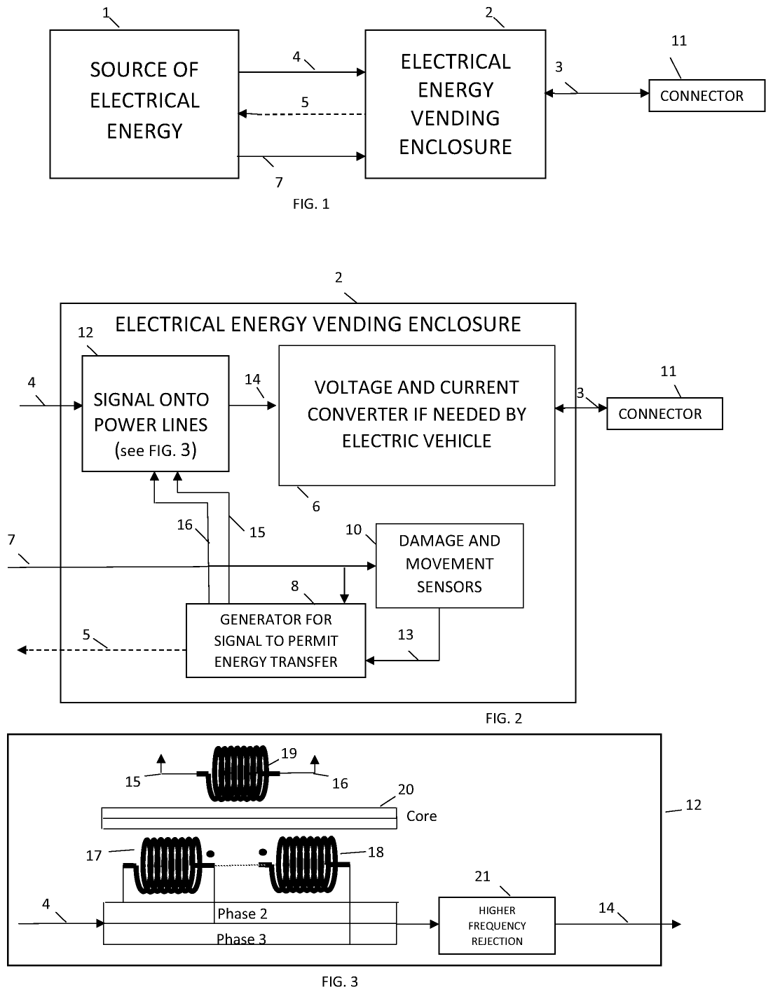

FIG. 1 shows an electric vehicle charging station consisting of a source of electrical energy 1, an enclosure for vending charging energy 2 with a cable 3 connected a connector 11 which is suitable for connection with the electric vehicle battery connector socket. Cable 3 is shown as going both directions as the electric vehicle sends to the enclosure a handshaking exchange of data to assure the proper voltage and current are being supplied. Connector 11 may also be part of an inductive wireless charging system where nothing is directly connected to the electric vehicle. This handshaking may also be done wirelessly and may also prevent the vehicle from moving while it is being charged. Power from the source of electrical energy is passed through wires 4 to enclosure 2 normally through conduit as the source of electrical energy and the vending enclosure are separated physically so make sure that any damage to the enclosure will not also damage the source of electrical energy.

A signal 5 flows from the electrical vending enclosure to the source of electrical energy assuring that it is safe to send said electrical energy. The line 5 is shown dotted as this safety signal could be in the form of wireless transmission. This safety signal is also sent on the wires 4 by a superimposed high frequency signal that causes a shut down if it is not received, assuring that none of the wires have been compromised. All signals must be present for the energy to be allowed to flow. This is discussed in more detail in FIGS. 2 and 3.

Referring now to FIG. 2 which is a block diagram of the inner workings of electrical energy vending enclosure 2. Line 7, between source of electrical energy and the vending enclosure, carries logic power operate the sensors 10 and power generator 8 of the safety signal. This logic power must be supplied separately as the system would not be able to start without the safety signal from generator 8 that allows the energy to flow between the source of electric energy and the energy vending enclosure.

Connector 11 and cable 3 perform as discussed in FIG.1 and are connected to the voltage and current converter if needed. If the converter, where not needed or the conversion was done at the source of electrical energy 1, line 14 would be connected directly to connector 11. Energy from the source of electrical energy 1 passes on wires 4 through box 12, more particularly described in FIG.3, where the signal to the source of electrical energy the that allows the energy to flow is impressed upon said wires. Line 7 of FIG.1 and FIG. 2 is the is the logic power for the damage and movement sensors 10 and the generator for the signal that permits energy transfer 8. It is important to note that the signal to be superimposed on the wires 4 is conducted from generator 8 on lines 15 and 16. If the power on line 7 is interrupted for any reason, the generator will not pe powered so no signal appears on line 5 or lines 15 and 16 and the power from the source electrical energy will be shut down.

Referring now to FIG. 3, line 4 is composed of two or three wires depending if the system operates on two or three phase power. If the system power is only two phase the Phase 3 wire and secondary 18 are omitted. When the total system is in operation as intended, the generator 8 of FIG. 2 places an alternating current signal of a higher frequency on lines 15 and 16 which are connected to the primary winding 19 of transformer 20. Secondary 17 connects to the Phase 1 and Phase 2 lines and causes the signal from the primary 19 to be connected between these two lines and is sent to the source of electrical energy. If, for any reason, the signal is not received at the source of electrical energy, the source of electrical energy is shut down. The same is true if the signal from secondary 18 which in connected between the Phase 2 and 3 lines does not arrive at the source of electrical energy. Even though the higher frequency signal from transformer 20 flows both directions on wires 4 it is high enough that it is rejected in the higher frequency rejection circuitry 21 so it does not flow on line 14. It is important to note that the two secondaries 17 and 18 are wound with opposite polarity so if only Phase 2 line becomes open the signals to Phase 1 and Phase 3 cancel each other and no signal is received at the source of electrical energy and it shuts down.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An energy vending system essentially comprising:
a source of electrical energy connected to an enclosure situated to vend electrical energy to an energy consuming device,
said enclosure equipped to:
send a safety signal to the source of electrical energy when no mal-function is detected such as improper movement of said enclosure, and
if the safety signal from said enclosure to the source of electrical energy is not received by said source of electrical energy the source of electrical energy shuts down.

2. An energy vending system of claim 1 wherein: said enclosure situated to vend electrical energy to an energy consuming device is located at a distance from said source of electrical energy such that damage done to said enclosure situated to vend electrical energy to an energy consuming device is unlikely to also be done to said source of electrical energy.

3. An energy vending system of claim 2 wherein said mal-function is detected by undesired movement of said enclosure situated to vend electrical energy to an energy consuming device utilizing one or more detection methods selected from the group consisting of: contact displacement sensors, contact displacement meters, non-contact displacement sensors, non-contact displacement meters, magnetic field, laser, ultrasonic wave, dial gauge, differential transformer, fixed reference transformer, mass-spring transformer, absolute position encoder, cable extension, capacitive, eddy current, fiber optic, Hall Effect, inductive, laser micrometer, linear fixed-reference transducer, mass-spring or seismic transducer, displacement transducers, piezoresistive accelerometers, servo accelerometers, force gages, ground sensing, impedance head, laser Doppler vibrometers (out of plane, scanning, and in-plane, rotational), precision micro-sensors, accelerometer preamplifiers, electro-dynamic transducers, electro-optical displacement, tilt and vibration sensors, inclinometers, tilt sensor, angle sensor, acceleration sensor, shock sensor, vibration sensor, precision micro, rugged package sensors, encoder, linear potentiometer, linear variable differential transformer, magneto resistive, change in position, optical triangulation, photo-electric, position probing, incremental encoder, rotary encoder, photo-junction, solenoid switching, time of flight optical, ultrasonic, variable resistance, limit switch feedback, and wireless position monitors, severed cable detector, severed cable sensor, cover tamper sensor, cover tamper switch, intrusion detector, intrusion sensor, and ground sensing sensors/system.

4. An energy vending system of claim 1 wherein: the signal to the source of electrical energy from the enclosure situated to vend electrical energy to an energy consuming device is in the form of a direct wired connection between the source of electrical energy and the enclosure situated to vend to an electrical energy consuming device.

5. An energy vending system of claim 1 wherein: the safety signal to the source of electrical energy from the enclosure situated to vend electrical energy to an energy consuming device is in the form of a wireless encoded connection between the source of electrical energy and the enclosure situated to vend energy to an electrical energy consuming device.

6. A method of assuring safe operation of an energy vending system wherein:
an energy vending enclosure situated to vend energy to an energy consuming device is remotely coupled to a source of electrical energy with a safety signal from the enclosure to the source of electrical energy that must be present for said source of electrical energy to flow. Said safety signal transmitted such that if any of the connections to the source of electrical are compromised in any form the source of electrical energy shuts down.

7. A method of assuring safe operation of an energy vending system of claim 6 wherein:
The safety signal is transmitted simultaneously over both power wires delivering energy to the energy vending enclosure from a source of electrical energy of a single phase system or one signal between phase 1 & 2 and a second signal between phase 2 & 3 on a three phase system.

8. A method of assuring safe operation of an energy vending system of claim 6 wherein:
all methods of transmitting said safety signal must be transmitting at the same time. If any one method of transmitting the safety signal fails and that safety signal does not arrive at the source of electric power as expected the source electric power is shut down. A method of assuring safe operation of an energy vending system of claim 6 wherein:
the logic power needed to power the sensors and the safety signal generating electronics that sends to the source of electrical energy an indication that no mal-function exists, is supplied by a source other than the wires that carry the main power from the source of electric power to the enclosure situated to vend electrical energy to an energy consuming device.
